(19) United States
(12) Patent Application Publication
(10) Pub. No.: US 2002/0138344 A1
(43) Pub. Date: Sep. 26, 2002

(54) Two-way communication system with a web-corresponding portable information terminal unit and an image display equipment placed in a public space

(76) Inventor: Mikio Fujita, Tokyo (JP)

Correspondence Address: Mikio FUJITA, 1-1002, SHIMOMARUKO 2-24-10, OHTA-KU, TOKYO, 146-0092, JP

(21) Appl. No.: 09/814,306

(22) Filed: Mar. 21, 2001

(51) Int. Cl. G06F 17/60

(52) U.S. Cl. 705/14

(57) ABSTRACT

To change one-way information transmissions by picture display equipment in the streets and public facilities to a two-way system using Web-corresponding type portable information terminal units (hereafter, “Portable Terminal Unit”).

For any information pictures which are shown by the screen display equipment in public places, the audience enter the personal ID number to display it. When the audience send the ID Number of interesting information to the providers through their Portable Terminal Unit, it becomes possible to exchange information at real time between the audience and providers and then, the two-way communication system will be established.

Two-way communication system with a Web-corresponding portable information terminal unit and an image display equipment placed in a public space.

### BACK GROUND OF THE INVENTION

This invention is concerned with a system in which picture information transmission is linked with Web-corresponding portable information terminal unit (hereafter, referred to as “Portable terminal unit”) through Web-server.

Currently, as any image information, including character information, is processed and modified by senders, it is required to put a telephone receiving center and to process collected opinions by many operators, in order to make general audience's opinions reflect on the advertisement.

This happens in any questionnaires in the same way, and it takes a lot of time and costs to select objective persons and add up their replies. While, only the role of receiver is emphasized in a Portable Terminal Unit, and no system has been provided to use it for expressing users' intentions.

The current system has the following defects.

1) In the side of Sponsors of advertisement,

a. It is not sure whether many unspecified people watch it with interest or not.

b. It is unknown through what media customers have got to know the goods.

c. It takes several weeks from advertisement cast day until sponsors find out the audience's response.

d. It is impossible to grasp the possible consumers quantitatively who have responded to a certain advertisement.

2) In the side of general audience,

e. Even if they find any goods or services which interest them, they do not know where they should access.

f. It is impossible to select information previously which may interest them, from so many telecasting advertisements.

g. It takes so much time to know the results of any complimentary services or prize competitions after application that people may lose interests.

h. There is a tendency that contents become more exciting to attract the attention (Ex. Nude image)

This invention shall build up a two-way communication system to solve the above defects by using Portable Terminal Units which are commonly used by many people.

### SUMMARY OF THE INVENTION

We will build up a system in which we display the ID Number of every program in an image display equipment placed in the streets currently and information is input directly from Portable Terminal Units commonly used by many people. Advertisement sponsors who wish to make their goods known to public by information media have their ID Numbers displayed on the screens by picture providers, according to the contract with information management companies. Information Managers set Main Server on Internet and provide their Home Page so that general people may download such information using their own Portable Terminal Units.

When ordinary audience find something interesting among various programs such as advertisements and introducing pictures, telecast in train stations or public facilities, they access Home Page set up by Information Managers using Portable Terminal Units, and request materials or apply for prize contests and reply to questionnaires.

Regarding how to recognize the audience, they are recognized by inputting their ID Number if they have been registered as the members. If they have not been registered, they may be registered temporarily by entering their cellular phone numbers. After such a temporary registration, they can enter their attribute information including their address for mailing any documents.

Input information from many unspecified consumers by Portable Terminal Units shall be accumulated in the server of Information Managers, via Communication Providers, to be changed to data base.

Such accumulated information are processed at a certain cycle, for instance every five minutes. In case of lots, such information is automatically processed by a program which automatically generates random numbers. As to the prize winners in a lottery or the total results of questionnaires are converted to data to be composed with pictures, which are processed further so that they may appeal to the audience's sense of sight.

The processed data for screen display are sent to the information dispatch center of picture provider at real time and then are displayed on the screens placed in the streets or public facilities through the picture transmission equipment.

If there are multiple display screens in such a serial of processes, it is possible to send the same information to all screens as well as to send different screens to each screen.

Every day, Information managers arrange the accumulated information in Main Server of Internet, such as the name/address of prize winners and people demanding any materials, to supply such arranged information to the advertisement sponsors.

The advertisement sponsors send prizes to the winners based on the supplied information, and give detail goods information to the people demanding the materials as potential users, or otherwise, they approach such people in various ways including visiting their residences individually to talk business.

By accumulating those results Information Managers are able to supply such information to new sponsors and the clients with an aim of marketing by questionnaire ,as more effective materials for projects.

For the general registered members, they shall make them enter any field in which they take interests and shall notice them in advance of any questionnaire information and telecasting advertisement schedule concerned with such fields.

### DETAILED DESCRIPTION OF THE INVENTION

Hereafter, the implementation form of this Invention is explained.

A. Information Managers shall operate and manage the whole system. According to the contract with advertisement sponsors, they shall indicate the picture transmitters for the screens in public facilities such as train stations to add the ID numbers to identify the programs. Also, they shall set up the special Home Page corresponding to the Portable Terminal Units and the Main Servers to accumulate information in Internet.

B. Unspecified consumers who own Portable Terminal Units may have the membership numbers by entering their attribute and field concerned previously if they are interested in the new service. Any consumers who have not been registered may have a temporary ID number by inputting the telephone number of their Portable Terminal Units. Consequently, those consumers are able to join the system as soon as they find any interesting information in the picture display equipment placed in the streets. In this case, they can enter personal attribute to receive the ID number of membership later.

Therefore, if consumers find out some interesting information in the picture display equipment in the streets or public places, they access the specified URL with Portable Terminal Units to input and send their ID and program ID numbers.

The input data are accumulated in the server of Information Managers through Internet. In case of the lots, lot process is executed automatically by the server and the winners are shown on the same screen in only few minutes. The winners are able to receive the notice with Portable Terminal Unit and to be given the prize or services on the spot.

C. The processes for one day end when they have telecast some advertisement pictures of the sponsors and accumulated the information of general public. Later, they transmit the total information such as the addresses of people demanding materials in a batch to the sponsors.

D. The clients, including advertising sponsors, may receive such responses as concrete and quantitative lists of potential customers and pay the consignment fee after having checked the results.

You can expect the effect to innovate greatly the questionnaire research contents aiming at the marketing and advertisements on the display screens placed in public facilities such as train stations and streets, by using the two-way communication system of this invention.

1) In the side of clients using questionnaires for advertisement,

a. It is possible to receive the information on the number, attribute distribution and potential user list as the response to advertisement effect in the following day and to make the market response reflect on their product strategy by grasping it at a quick cycle.

b. It is possible to grasp the effect of advertisement against its cost by detailed units, for every media or every place.

2) In the side of picture producers,

c. An appropriate evaluation is expected for high-quality contents, because they get to know the effect of appealing pictures quantitatively at real time as the impact on general consumers.

3) In the side of general consumers, it is possible to access any interesting information easily.

d. It is possible to apply for the lots or premium goods easily as well as to confirm their results at once.

f. The opportunities to express own opinions about current fashion or trend and to make such thoughts reflect on the actual products will increase

4) In the side of the public facility managing agencies,

g. As advertisement sponsors will compete not by senseless nude pictures but by the information content, the moral environment will be improved.

5) In the side of communication business,

h. Since the information input function of Portable Terminal Units attracts more attention, they may expect further improved functions and more sales of Web-corresponding type portable information terminal equipment.

What is claimed is:

1. The I.D. of a program is displayed on an image display equipment which is placed in advance in public facilities, including inside/outside of the railway stations, air port lobbies, public squares, halls or walls/roofs of buildings. In the system, when general people watching the program take an interest or feel sympathy in it, they respond immediately by their own Web-corresponding information terminal units which they are carrying with. It is a two-way communication system in which Information Managers install Web-server and Data base on Internet previously, process immediately transmitted information input by the audience, and display response information through live telecast images or accumulated pictures. Information Managers install a Web-server corresponding to Web-corresponding type portable information unit such as WAP, i-mode (hereafter, referred to as “Portable Terminal Unit”) on Internet and open Home Pages where an input screen is provided for collecting information. A contract is made with a sponsor who wishes to telecast advertisements effectively, and an image display equipment is placed in public facilities including the railway stations or on the walls in the streets. Information Managers have a provider of advertisement or tourism information displayed additionally the ID Number of each program. Any audience viewing the pictures will request some materials to Web-server by their portable terminal units, when they have found interesting goods or services . To promote such requests, it shall be noticed in advance that free gifts or discount tickets are to be given by lots. Based on information collected through Web-servers, the add-up and lot processes are automatically executed and the results are displayed on the live screen. Each personal information is stored to create Data base for sending any goods or materials/prizes. Such data base is used to manage individual information as membership and to classify audience into various categories when any questionnaires are to be sent. It is a kind of business system in which you can improve advertising effects and a real time or on-site marketing becomes available by quantifying the attracting level of image advertisements aiming at unspecified audience.
